(19) United States
(12) Patent Application Publication
(10) Pub. No.: US 2024/0271301 A1
(43) Pub. Date: Aug. 15, 2024

(54) SCALABLE FLOW FIELD FOR AN ELECTROCHEMICAL CELL AND METHOD OF HIGH-SPEED MANUFACTURING THE SAME

(71) Applicant: EvolOH, Inc., Palo Alto, CA (US)

(72) Inventor: Scott BLANCHET, Chelmsford, MA (US)

(21) Appl. No.: 18/434,336

(22) Filed: Feb. 6, 2024

Related U.S. Application Data
(60) Provisional application No. 63/483,658, filed on Feb. 7, 2023.

(51) Int. Cl. C25B 13/02; C25B 9/19; C25B 9/75; C25B 9/77; C25B 11/031; C25B 11/036; C25B 13/05

(52) U.S. Cl. CPC C25B 13/02; C25B 9/19; C25B 9/75; C25B 9/77; C25B 11/031; C25B 11/036; C25B 13/05

(57) ABSTRACT

The present application relates to a flow field for use in an electrolysis cell comprising one or more sheets of porous material with a corrugated structure. The electrolysis cell comprises a membrane, an anode, a cathode, an anode reinforcement layer, a cathode reinforcement layer, an anode flow field, a cathode flow field, and a bipolar plate assembly comprising an embedded hydrogen seal. The anode flow field comprises one or more porous sheets having at least one straight edge and at least one of the porous sheets has the form of a corrugated pattern with a plurality of peaks and valleys whose axes are generally aligned with one straight edge of the sheet. The anode flow field geometry simultaneously provides resiliency, for efficient mechanical compression of the cell, and well-distributed mechanical support for the anode reinforcement layer adjacent to the anode flow field.

### INCORPORATION BY REFERENCE OF RELATED PATENT APPLICATIONS

This application is based upon and claims the benefit of priority under 35 U.S.C. § 119(e) to U.S. Provisional Application No. 63/483,658, filed Feb. 7, 2023, the entire contents of all of which are incorporated herein by reference in their entirety.

### FIELD OF INVENTION

The present disclosure relates to electrochemical cells and stacks, more particularly, to components for electrochemical cells and stacks designed for scalable active areas and high-speed manufacturing.

### BACKGROUND

Electrochemical cells are devices for inducing chemical reactions using electricity or generating electricity using chemical reactions. If electricity is the output, the cells may be considered fuel cells or expander cells, depending on the chemical product. If electricity is the input, the cells may be considered electrolyzer cells, compressor cells or purifier cells, depending on the chemical product. For example, an electrolyzer takes electrical energy and stores it in a fuel such as hydrogen by splitting water into its constituent elements. In contrast, a fuel cell may be thought of essentially as an electrolyzer running in reverse—hydrogen and oxygen are provided to the cell, which then combines these molecules to form water, releasing electrical energy in the process. Other chemical reactions may be promoted by use of an electrochemical cell or stack of cells such as the reduction of carbon dioxide into carbon monoxide, ethylene, or ethylene glycol, the reduction of nitrogen into ammonia or associated compounds, the formation of hydrogen peroxide from water and oxygen or the extraction of lithium from lithium brine solutions. The basic elements of these devices are two electrodes, an ion-conducting electrolyte, and an ion-permeable layer separating the two electrodes, although it is possible to operate an electrolyzer or fuel cell in a membrane-less configuration, as well. Electrochemical cells may also include a separator between the electrodes to prevent products from mixing inside of the cell. In the case of solid-electrolytic cells, the membrane and separator may be combined into a unitized, solid, ion-conducting layer. A complete electrochemical cell may also include flow fields for delivering reactants to the electrodes, seals for isolating reactants from each other and the environment, and one or more impermeable separator plates, also referred to as bipolar plates, for isolating one cell from adjacent cells in a stack and, in certain embodiments, for containing a separate cooling fluid for thermal management of the cell.

A variety of electrolytes can be used in electrochemical cells, including proton exchange membranes, anion exchange membranes, solid-oxide ceramic membranes, and liquid alkaline solutions such as potassium hydroxide and sodium hydroxide. Different electrolytes demand different operating conditions, and each comes with its own benefits and limitations. Advantages of proton and anion exchange membrane electrolytes may include relatively low operating temperature and a cell that can be constructed using a unitized-layer electrolyte/membrane. Electrolyzers using such membranes have the distinct advantage over other electrolyzers of being able to operate using relatively pure, liquid water, rather than a caustic solution or water vapor as a feed stock, thereby greatly simplifying the balance of system in practice. Relative pure water may be defined as water containing no more than 1% by weight of elements other than hydrogen and oxygen. Such electrolyzers may also be operated without liquid water on the cathode, allowing production of hydrogen in a gas phase having non-zero vapor-phase moisture content. A non-zero vapor-phase moisture content may be defined as gas containing more than one part per million water vapor, by volume.

The impact of carbon dioxide on global climate change is well-documented. As society's efforts to address global climate change accelerate, the need for deep decarbonization of most or all human energy use has become clear and urgent. The use of hydrogen as a carbon-free energy carrier is essential to reaching certain segments of human industry that are difficult or impossible to decarbonize directly with electricity. Examples of such segments include steel production, fertilizer manufacturing, construction, and heavy transport such as trucking, marine and air vehicles. In addition to these segments, the energy density and stable storage characteristics of hydrogen has made it the most viable candidate for seasonal-scale energy storage and establishment of grid resiliency using only renewable electricity, which will be required for complete conversion of energy use to carbon-free sources. These and other benefits have driven a high level of interest in “green hydrogen” production.

Hydrogen is given a “green” label if it is produced by electrolysis from renewable electricity (wind, solar, hydropower, etc.). Other “colors” of hydrogen are conventionally assigned to other energy sources. The scale required to meet the potential demand for green hydrogen in the future global energy system is daunting. Production capacities for electrolyzers will need to increase by many orders of magnitude and their costs reduced by a factor of ten or more over the next decade to meet such demand. Up to now, production of hydrogen electrolyzers has been a niche industry with small systems and limited deployments based on cells and stacks designed for research and development. Only minor considerations have been made for the speed of manufacturing necessary to produce and assemble cells and stacks at a rate commensurate with society's eventual need.

### BRIEF SUMMARY

Recognizing the urgent need for innovative electrolyzer technology in fighting climate change, the present application is directed toward a flow field for a scalable electrolysis cell and stack, a scalable electrolysis cell and stack, a scalable stack compression system, and method of high-speed manufacturing. Embodiments of the present application are directed to the design and manufacturing of a critical element for these cells and stacks: the fluid flow field. The flow field is a component in the cell assembly that provides the open space necessary for reactants and products to flow continuously into and out of the operating cell and stack. Such flow fields may comprise other functions within a cell such as uniform mechanical load distribution to membrane and electrode layers as well as conduction of electricity through the cell. The present disclosure includes innovative arrangements of flow field component geometry and dimensions that facilitate advantages related to assembly and compression of cells within electrochemical stacks. The present disclosure also includes improved geometry and dimensions for electrolysis cells with a small overall thickness relative to prior art. The present disclosure also includes innovative arrangements of flow field component geometry and dimensions that facilitate advantages related to the evolution and removal of gas bubbles evolved during the reaction on the liquid-flow side of the cell. The present disclosure also includes innovative methods for manufacturing flow field components with higher speed relative to prior art. The description below will focus on water electrolysis for hydrogen production for clarity, but may be applied to other electrochemical processes by one skilled in the art.

The basic process of water electrolysis involves providing water to a positively charged anode and conducting ions between the anode and a negatively charged cathode. Oxygen gas is produced at the anode while hydrogen gas is produced at the cathode. The particular ion conducted between the anode and the cathode depends on the electrolyte used. In an acidic cell, positively charged hydronium ions (H₃O⁺) are conducted from the anode to the cathode. In an alkaline cell, negatively charged hydroxide ions (OH) are conducted from the cathode to the anode. In both systems, the overall reaction is the same: (2) H₂O(l)→(2)H₂(g)+O₂(g). Electricity must be provided to drive the reaction. The open-circuit, or thermo-neutral, voltage for the basic reaction of hydrogen to liquid water is 1.481, therefore a voltage higher than 1.481 must be applied to a hydrogen electrolysis cell fed with liquid water to cause the reaction to progress (as discussed below, an overpotential is usually required for the reaction to proceed at acceptable rates). The size (i.e., active area) of the cell determines the rate of hydrogen/oxygen production from one cell at a given applied voltage. The total current required for a particular applied voltage may be proportional to the active area of the cell. In practical systems, multiple cells may be “stacked” on top of each other to increase production capacity. This stacking of cells results in the need to apply a higher voltage (integer multiple of the cell count) to drive the reaction. For example, a single cell of 1000 cm² active area may produce the same hydrogen flow as two stacked cells of 500 cm², but the 500 cm² stack will require an input of 2 times the voltage and ½ of the current. Flexibility in selecting required voltage and current may be a significant consideration in the design and cost of a total electrolysis system. For example, power supplies for higher current and lower voltage may be more expensive than those for higher voltage and lower current due to the size of the required electrical conductors and additional materials required for their construction. Therefore, an easily scalable cell active area is a significant advantage for cost and flexibility of deployment.

The elements of a hydrogen electrolyzer stack may include a stack of repeating components (configured as repeating “cells”) and a system of non-repeating components to hold the cells together in a stacked configuration. As the name implies, the repeating components are those whose quantity scales with stack height and may typically include the membrane/electrolyte, anode and cathode electrodes, anode and cathode electrode reinforcement layers, water and hydrogen flow fields, water and hydrogen seals, and a bipolar cell separator plate. The non-repeating components may typically include end units and a mechanical system for maintaining compression on the stack of repeating components (the “stack core”), along with power terminals, electrical isolators, fluid distribution and/or drain/purge manifolds. The stack compression system may include compliant elements such as tension members, springs, and adjustable members (rods, bolts, wedges, etc.) to generate and maintain compressive loading in the stack core. This compression of the stack core may be essential to ensure both electrical contact and fluid sealing between individual cells and with the end units. In a typical electrolyzer stack, the compliant elements may be located outside the stack core, as the core itself may be relatively “stiff” mechanically. In this case and relatively “soft”, or compliant, compression system, external to the stack core, may be required to ensure ongoing compressive load is maintained as the stack height changes with time or temperature or pressure. These external elements may be large and/or expensive and/or cumbersome for manufacturing. Alternately, repeating components with built-in compliance may enable a designer to minimize or eliminate the need for substantial external springs, rods, bolts, etc., leading to an advantage in cost, size, and speed of assembly for the stack. In this context, compliance may be defined as the inverse of an effective elastic spring constant along a z-axis, which is an axis aligned with the axis of stacking cells (i.e., change in “z” [mm] per unit of applied force [kgf])

The present disclosure is directed toward a novel structure for the fluid flow fields of a scalable electrolysis cell and stack. A flow field is an element of a cell that provides open space for cell reactants (e.g., water) to be delivered to the cell active area and for cell products (e.g., hydrogen, oxygen) to be collected from the cell active area. In a traditional electrolysis cell, the flow fields may comprise a series of channels formed in the bipolar plates. Channel-like flow fields present significant challenges in electrolysis due to lack of scalability and the need for relatively large thicknesses to maintain reasonable water pressure loss through the small channels formed. In the present disclosure the flow field comprises a three-dimensionally contiguous open space (an “open flow field” or “OFF”) formed using a porous material to maintain separation of the electrode from an adjacent cell under the compressed load applied to the cell. The OFF may also conduct electricity through the open space, between the electrode and an adjacent cell.

Prior constructions of OFFs for electrolysis cells consist of metallic foams, sintered metal frits, flat wire meshes, expanded metal meshes, and perforated sheets in a variety of configurations. These OFFs are flat structures, with low porosity and, like channels, require large thickness cells to provide reasonable water pressure loss. These cells are relatively stiff (non-compliant) along a z-axis and may require large, costly, and inconvenient compression systems to maintain cell-to-cell contact and sealing throughout the lifetime of a stack of such cells. Prior approaches to OFFs in fuel cells have included formed porous sheets, such as corrugations and dimpling of thin flat sheets to provide greater volume and lower pressure drop for gas flows in these devices. Fuel cells, however, do not have the issues of gas bubble management present in electrolyzers and these prior art flow fields have, therefore, not been adapted for two-phase flows and gas bubble evacuation. Prior approaches to OFFs have significant limitations in terms of size, cost, flow resistance, cell performance and manufacturability, which the present disclosure aims to overcome.

In some embodiments, the present disclosure comprises a scalable flow field, which may be used as an anode flow field and combined with a bipolar plate assembly including a scalable cathode flow field that further comprises an embedded hydrogen seal. In this configuration, the porous cathode flow field provides both mechanical reinforcement for hydrogen seal and the open space for collecting and directing hydrogen gas flow away from the active area of the cell. The hydrogen seal may be fully embedded within the porous structure of porous cathode flow field, forming a gas tight seal for hydrogen gas in the cathode while also physically adhering the components of the bipolar plate assembly together. In this configuration, with the hydrogen seal coincident with the porous flow field along a z-axis, the cathode flow field may be made very thin. Minimizing the thickness of each repeating cell in the stack core may be important to achieving a small stack with high output (i.e., high power density). Achieving built-in compliance with repeating components that are very thin may be challenging since, fundamentally, thin components (i.e., short “springs”) are stiffer than thick components. The materials and geometry of the anode flow field may be important to developing a stack core with adequate compliance as this component may be relatively thick compared to other layers in each cell, including the cathode flow field.

In some embodiments, the present disclosure may comprise a scalable flow field configured to enable improved compressive load distribution to the membrane and electrodes in conjunction with a selected electrode reinforcement material. Uniform compressive load application to the electrodes and membrane may be important to cell performance and lifetime. One or more corrugated layers may have dimensions selected to minimize bending under load for the electrode reinforcement, resulting in more uniform transfer of mechanical load through the reinforcement to the electrodes and membrane. The peak-to-peak (i.e., “corrugation pitch”) dimension for the layer adjacent to the electrode reinforcement may be selected based on the elastic properties and thickness of said reinforcement to accomplish this function.

In some embodiments, the present disclosure may comprise a scalable flow field configured to provide relatively high compliance along a z-axis, thereby enabling use of a compact, low-cost, and convenient stack compression system with minimal requirements for spring function.

For convenience we may define a cartesian coordinate system with perpendicular x-y-z axes where “x” is parallel to the general direction of water flow through the stack, “y” is perpendicular to x, but in the same plane defined by a single cell, and “z” is generally parallel to the direction of stacking of the cells. In this context the compression system generally works to apply compressive load along the z axis, holding the cells and their various repeating components in contact with each other. Compliance of the stack core may then be measured along a z-axis, so defined.

As the electrolyzer is operated, water is consumed and hydrogen+oxygen gases are produced, therefore water must be continuously provided to the cell to feed the reaction. Stoichiometry is a term relating to the “balance” of a chemical reaction. In electrochemical cells, the term “stoichiometry” or “stoich” refers to the ratio of reactants fed to a cell relative to the amount required to exactly balance the overall reaction. For example, an electrolysis cell operating at a water stoich of 2 would have as its input twice the amount of water required to produce the hydrogen and oxygen exiting the cell. Conserving mass for the system at 1 stoich shows that 1 kg per hour of hydrogen production is associated with approximately 8 kg per hour of oxygen production and approximately 9 kg per hour of water consumption. Typically, electrolyzers may be run with a minimum water stoich greater than 1 to ensure adequate reactants everywhere in the cell. For example, at a water flow stoich of 1, all of the water provided to the cell may be converted to oxygen on the anode, making the oxygen fraction at the cell outlet 100% (i.e., no water exiting the cell). This condition may be unstable and could result in damage due to anode starvation of the cell near the outlet. It may also result in high fluid velocity and pressure loss at the outlet as everything leaving the cell is vapor. Process conditions may therefore be selected to maintain an oxygen vapor fraction at the cell outlet below a given threshold. For example, an outlet oxygen fraction of <40% may result in less than a 2× increase in flow field velocity from water inlet to outlet. To maintain <40% oxygen fraction, a water stoich of up to or greater than 100 may be required. The materials and geometry selected for the anode flow field, which delivers the water and removes the oxygen from the cell, may also be important to maintaining high performance and low pressure drop. Geometry and dimensions that minimize velocity while promoting the convection of oxygen bubbles away from the anode electrode may provide such advantages.

The electrolysis process is not 100% efficient, and, as a result, some of the input electricity is converted to heat within the cell rather than chemical energy stored as hydrogen. This results in voltages greater than the thermo-neutral voltage (1.481) being required for practical hydrogen output flow rates. Conserving energy for the system can show that the fraction of electrical power (voltage times current) delivered to the cell that goes into heat may be equal to [1−(1.481/V_{cell})]. A practical electrolysis cell may operate at 1.8V, which results in [1−(1.481/1.8)]=˜18% of the power sent to the cell turning into heat rather than hydrogen. Therefore, practical electrolysis cells require cooling during operation and an efficient way to accomplish this cooling may be by utilizing the process water itself to cool the cells. Depending on the operating conditions of the cell, a relatively high flow rate of water may be required to ensure the peak temperature of the cell is kept below an acceptable threshold and the temperature gradient within the cell is also acceptable. This flow rate may also represent a water stoich much greater than 1. For example, for a cell operating at 1.8V, releasing 18% of the input energy into heat and operating at 2.7 W/cm², a water stoich of greater than 100 may be required to maintain a temperature rise of <10° C. across the cell. From the design considerations described above, water flow rate into the cell may be determined by the need for adequate reactants or by the need for adequate temperature control, whichever is higher.

Managing the water provided to a hydrogen electrolysis cell/stack may, therefore, be a major consideration for the overall hydrogen generation system. Flow rate, pressure, temperature, and composition must all be regulated to meet the requirements of the cells and stack. A typical system may include a liquid-gas separator, heat exchanger, pump, and purification/de-ionization system connected in a loop with the anode side of the cell/stack to recirculate water at the required flow rate. As the system produces hydrogen and oxygen, one “stoich” of water is consumed. Consumed water (i.e., “make-up water”) may be added to the system by injecting 1 stoich of new water into the system loop from a source of acceptable quality (e.g., demineralized, de-salinized, “buffered”, or city water). When considering the scale of an electrolysis plant, the required water flow consumed by the cells/stacks may be proportional to the plant capacity. It may be desirable to keep other process parameters (pressures, temperatures, compositions) uniform regardless of scale as it may greatly simplify system component selection, overall system controls and the cost of engineering, procurement, and construction (EPC) at the deployment site. For example, water pumps may be generally commercially available at a wide range of scale in flow rate for a given pressure capability. It may, therefore, be advantageous to have a basic cell/stack whose water flow resistance is minimized and not dependent on cell or stack size. Larger systems could then be constructed in a modular fashion, from more cells and/or more stacks without requiring a change in water pump technology and basic pressure ratings for the system and plant. Given the high flow rate of water required by these considerations, the materials and geometry of the anode flow field represent important considerations for minimizing pressure loss, enabling active area changes without changing the pressure loss, and, thereby, reducing the costs of water pumps for an electrolysis system.

In some embodiments, the present disclosure may comprise a scalable flow field configured with substantially equal resistance to water flow, equal temperature-rise, and equal exit oxygen fraction at a given operating voltage regardless of selected active area. In some embodiments, the flow field may be substantially rectangular, characterized by a dimension along an x-axis which is selected according to a roll web width (w) of the flow field material used in its production. In some embodiments, a desired roll web width (w) may be selected based on maintaining process parameters for the operating cell within target threshold values. For example, it may be desirable to keep a water pressure drop for the cell below a pumping pressure limitation of the system into which the cell may be installed. Alternately, it may be desirable to keep a water flow temperature rise along an x-axis below a stack temperature gradient limitation to ensure acceptable performance and lifetime. Alternately it may be desirable to maintain a temperature gradient within a cell long a z-axis below a cell temperature gradient limitation, which may require cells to be made as thin as possible to promote effective internal heat transfer. Alternately, it may be desirable to keep cell outlet oxygen volume fraction below a limit that ensures stable performance and lifetime of the cell. Alternately, a desired roll web width (w) may be selected based on available source materials for constructing the flow field. For example, it may be desirable to select a roll web width that minimized scrap material in converting rolls into flow field pieces during assembly. In this case the desired roll web width for the membrane, the electrodes and the flow fields may be the same or different. If they are different, the selected roll web width may be chosen based on the most expensive of the membrane, the electrodes or the flow fields and the other material rolls may be selected with a web width (w) consistent with the others, where consistent implies a roll web width (w) that improves manufacturing speed and/or overall cost. Cells of various active areas may then be constructed by varying dimension only along a y-axis, greatly simplifying material sourcing and manufacturing processing of coils of a fixed web width.

In some embodiments, the present disclosure may comprise a variable cell achieved using the scalable flow field by adjusting the length of the cell along a y-axis. Water distribution windows may be arranged parallel to a y-axis, along a leading edge of the anode flow field and each window may be associated with a unit length along a y-axis of the anode flow field [“ULAFF” for short]. A leading edge of an anode flow field may be defined as the edge through which water enters the anode flow field. The area, or effective diameter—a diameter of a circle whose area is equal to that of the window—of each water distribution window may be selected to maintain water velocity along a z-axis through the window below a predetermined threshold at a water flow stoich selected to maintain one or more of a cell temperature-rise or an oxygen outlet volume fraction below a target threshold. The ULAFF associated with each water distribution window may be selected to keep a water velocity along an x-axis at the leading edge of the anode flow field below a predetermined threshold. The number of water distribution windows may then be selected to achieve the overall target hydrogen production rate for the cell while maintaining water flow pressure loss, water temperature-rise and oxygen outlet volume fraction below a target threshold.

In some embodiments, the present disclosure may comprise a scalable flow field comprising one or more metal meshes, expanded metal sheets or perforated sheets where at least one of the sheets is corrugated into a wave-like pattern effectively increasing its thickness along a z-axis. This geometry may provide greater volume for a given amount of flow field material, effectively increasing the porosity and thickness of the flow field relative to non-corrugated sheets, which would result in a reduced water flow velocity and a lower pressure loss. Multiple corrugated layers may be combined to adjust pressure drop, gas bubble evacuation, compressive load application, and mechanical compliance along a z-axis within the cell. Further configuration of both materials and geometry for the flow field layers may allow electrolysis cells of high compliance with smaller thickness while simultaneously providing a lower pressure loss than prior art.

Simultaneously satisfying requirements for flow restriction, gas bubble evacuation, mechanical load distribution, and elastic compliance may be particularly challenging for electrolyzers utilizing open flow fields and solutions are not obvious to those skilled in the art.

It is to be understood that both the foregoing general descriptions and the following detailed descriptions are exemplary and explanatory only and not restrictive of the disclosure, as claimed. Further objects, features, and advantages of the present application will become apparent from the detailed description of preferred embodiments which is set forth below, when considered together with the figures of drawing.

### BRIEF DESCRIPTION OF DRAWINGS

The accompanying drawings are incorporated into and constitute a part of this specification. The drawings illustrate certain embodiments only of the present disclosure and, together with the foregoing and following descriptions, explain the principles of the disclosure. Wherever possible the same identification numbers have been used to indicate common or like components across different figures.

FIG. 1 shows a cross-sectional view of a preferred embodiment of the layers of a scalable electrolysis cell of the present disclosure.

FIG. 2 shows an isometric view of a preferred embodiment of a scalable electrolysis cell including the presently disclosed, scalable flow field.

FIG. 3 shows several prior art flow fields used in electrolyzer and fuel cells.

FIG. 4 shows an isometric view of a scalable bipolar plate assembly (“BPA”) including an embedded hydrogen seal.

FIG. 5 shows a cross-sectional view of the BPA of FIG. 4, illustrating how the embedded hydrogen seal fully penetrates in the cathode flow field to form a gas-tight, reinforced seal with minimal thickness long a z-axis.

FIG. 6 shows mathematical model output for oxygen volume fraction at the outlet versus water stoich value for an exemplary cell operating pressure and an illustrative oxygen volume fraction threshold.

FIG. 7 shows mathematical model output for water temperature rise versus water stoich value for two exemplary cell operating voltage values and an illustrative water temperature rise threshold.

FIG. 8 shows published scientific results of the structure of fluid flowing over a channel, illustrating the impact of channel dimensions on vortices within the channel.

FIG. 9 shows an isometric view of a preferred embodiment of a scalable flow field and an associated electrode reinforcement illustrating an orientation for water flow and the associated fluid dynamic properties of the flow field elements, which may simultaneously minimize water flow pressure loss and promote bubble evacuation from the anode electrode.

FIG. 10 shows a cross-sectional view of a preferred embodiment of a scalable flow field and an associated electrode reinforcement, as shown in FIG. 8, illustrating the relative geometric dimensions of various elements, which promote uniform distribution of compressive load to the electrode and membrane, and which promote fluid dynamics for efficient bubble evacuation from the anode electrode.

FIGS. 11A, 11B, and 11C show a cross section of a preferred embodiment of a scalable flow field illustrating the elastic deformation of the flow field when exposed to a compressive load along a z-axis.

FIG. 12 shows preferred embodiment of a scalable flow field illustrating unitization of a plurality of layers by means of spot welding.

FIG. 13 shows a preferred, high speed, continuous method of fabrication for a scalable flow field.

FIGS. 14A and 14B show a comparison of a prior art stack compression system (FIG. 14A) to an efficient stack compression system (FIG. 14B), which may be enabled by various embodiments of a compliant flow field.

FIGS. 15A and 15B show load uniformity test results comparing a preferred embodiment of the present invention to prior art.

FIG. 16 shows the results of finite element simulations computed for a series of exemplary corrugated porous sheet geometries. A compressive modulus “E” may be defined by traditional engineering convention as the ratio of measured stress to measured strain in a material exposed to a compressive loading.

FIG. 17 shows the characteristic flow resistance [millibar per centimeter, mb/cm] vs. water flow velocity [centimeters per second, cm/s] measured for a number of exemplary flow fields.

### DETAILED DESCRIPTION OF DRAWINGS

Detailed descriptions of several preferred embodiments will now be given in reference to the accompanying drawings. Although descriptions relate to water electrolysis, it is understood that the described features, components, and methods are applicable and adaptable, by those skilled in the art, to other electrochemical technologies including reduction of carbon dioxide into carbon monoxide, ethylene, or ethylene glycol, the reduction of nitrogen into ammonia or associated compounds, the formation of hydrogen peroxide from water and oxygen or the extraction of lithium from lithium brine solutions, hydrogen compressors, hydrogen purifiers, and fuel cells.

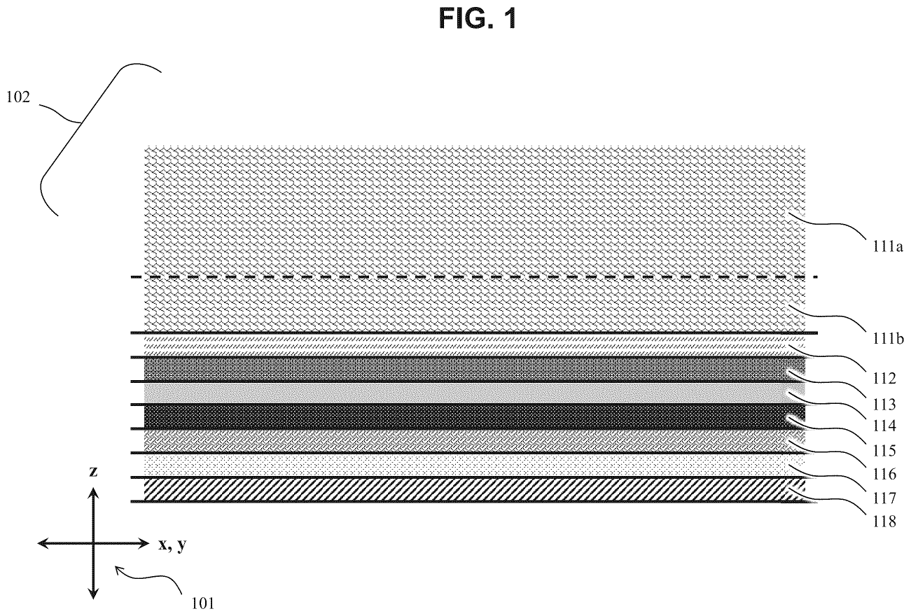

FIG. 1 shows a schematic representation of a cross section of a typical electrolysis cell (102) according to the present disclosure. Layers are shown in relative position to each other, being positioned generally in an x-y plane and stacked along a z-axis (101). Each layer may be thicker or thinner along a z-axis than shown relative to other layers in the cell. Layer (111) represents an anode flow field, which may comprise more than one layer, (a), (b), etc. (only 2 layers, a and b, shown). Layer (112) represents an optional anode electrode reinforcement layer. Layer (113) represents an anode electrode layer. Layer (114) represents an electrolyte membrane layer or a liquid electrolyte. Layer (115) represents a cathode electrode layer. Layer (116) represents an optional cathode electrode reinforcement layer. Layer (117) represents a cathode flow field layer. Layer (118) represents bipolar separator plate layer.

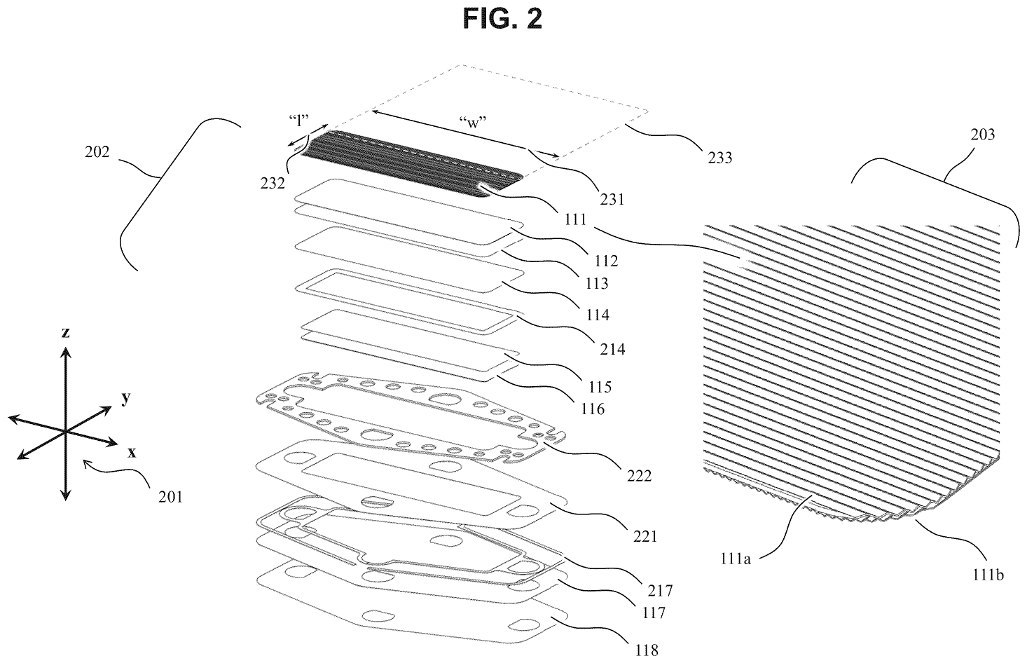

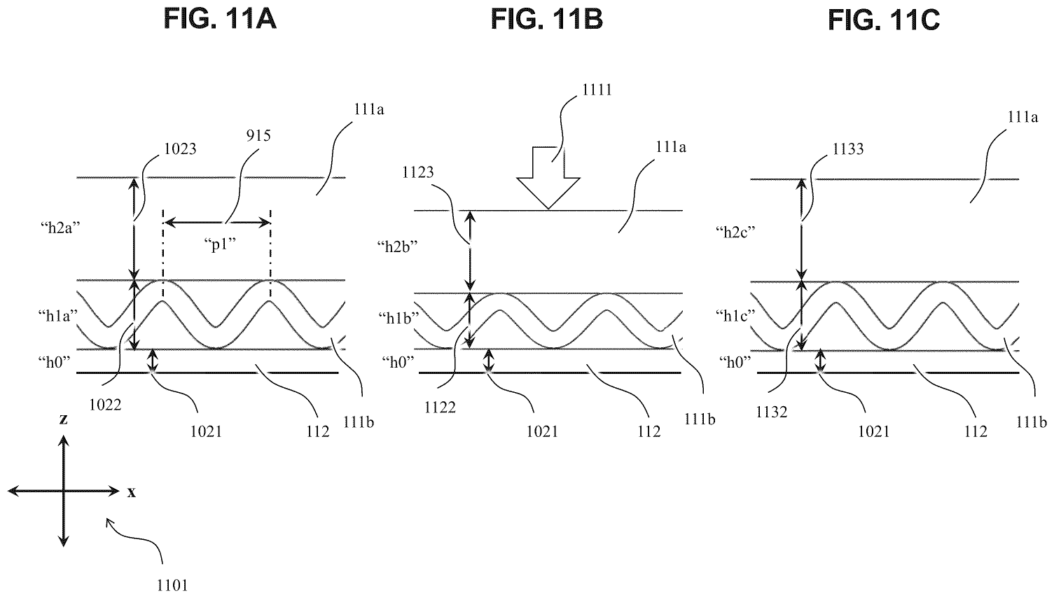

FIG. 2 shows a 3D isometric view (202) of the cell layers depicted in FIG. 1 with the addition of several components. Component (217) represents a hydrogen seal. Component (221) represents a cell frame. Component (222) represents a water seal. Component (214) represents an internal seal. The anode flow field (111) is represented in this embodiment as a two layer corrugated laminate (111a, 111b) as shown in the detail view (203). During operation, the anode flow field (111) may function to deliver and distribute water to the cell active area as a reactant, deliver and distribute water to the cell active area as a coolant, and to collect and remove oxygen gas from the active area as a product. During operation hydrogen gas may be evolved over the active area, collected, and removed by the cathode flow field (117). Fluid within the cathode flow field may be primarily gas phase with a non-zero water vapor content due to evaporation of water transported through the membrane from the anode. Due to the relatively low flow rate of fluid in the cathode flow field relative to the anode flow field, the cathode flow field may be designed with a relatively thin dimension along a z-axis. For example, a cathode flow field (117) may have a thickness along a z-axis of less than 2 mm, less than 1 mm, less than 0.5 mm, or less than 0.25 mm. The relatively thin z-axis dimension of the cathode flow field may contribute advantageously to a thin thickness of the overall cell; however, it may also result in it being mechanically stiff (non-compliant) along a z-axis. This non-compliance inherent in a thin cathode flow field may place additional burden on designing an anode flow field with adequate compliance, further discussed below with respect to FIG. 11. The width, “w” (231) of anode flow field (111) is aligned with an x-axis (201), while the length “l” (232) is aligned with a y-axis (201). Scaling of the anode flow field, and other repeating components, may be accomplished by increasing their dimensions along a y-axis (233).

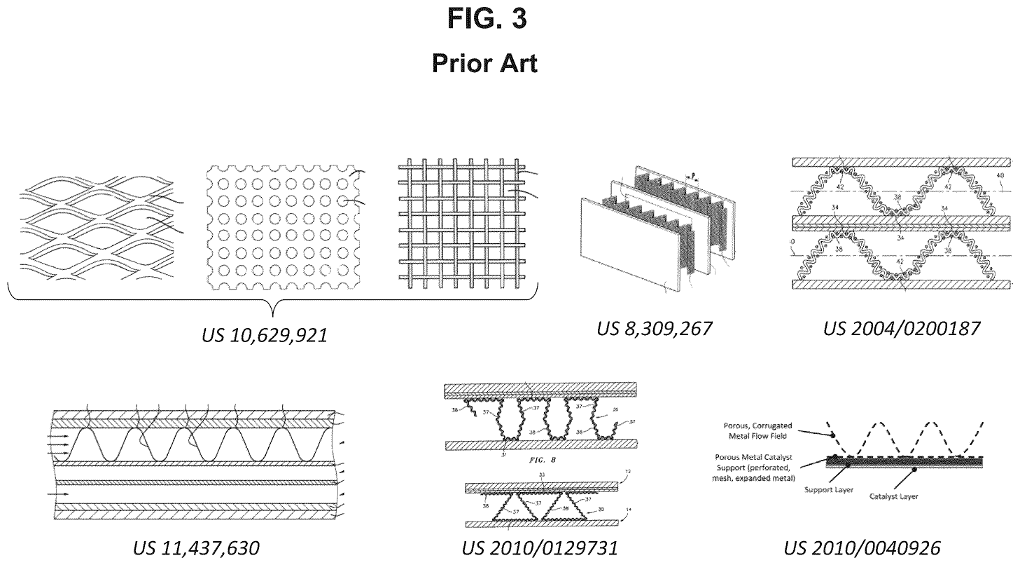

FIG. 3 shows a few examples of prior art flow fields used in electrolyzers and fuel cells. In addition to flow fields in the form of channels (not shown) formed directly into the bipolar separator plates in some prior art, distinct spacer components have included flat wire mesh, expanded and perforated metal sheets, and 3-dimensionally formed versions of these. It is the objective of the present disclosure to overcome limitations of prior art configurations for electrolysis applications by providing a relatively thin electrolysis cell which simultaneously provides for high mechanical compliance along a z-axis, uniform compressive load distribution to electrodes and membranes, and an advantageous geometry for gas bubble evacuation from the electrode. The disclosed cell may thereby enable simplifications of an associated stack compression system by providing necessary mechanical compliance along a z-axis within the core stack of cells, thereby obviating the need for springs and other compliant members in the external compression system.

Thin electrolysis cells may enable the stacking of more cells in a single stack and result in a greater power density (kilowatts per liter, kW/L) for such a stack. Thin electrolysis cells may have a dimension along a z-axis of less than 5 mm, less than 3 mm, less than 2 mm or less than 1.75 mm. Therefore, a thinner a thinner cell may result from a thinner flow field, thereby indicating a better flow field design and a greater “Figure of Merit—FoM” for the design.

High mechanical compliance along a z-axis may be defined by a “compliance ratio” defined as the ratio of a compressive modulus along a z-axis for an un-corrugated porous sheet “E₀” to a compressive modulus along a z-axis of a corrugated porous sheet “E₁” made of the same material (compliance ratio—E₀/E₁). Values of compliance ratio greater than 2:1, greater than 5:1, greater than 10:1, greater than 25:1, or greater than 100:1 may provide advantageous compressive load distribution and advantageous simplification of requirements for external cell and stack mechanical compression systems. Therefore, a larger compliance ratio may result in a better flow field design and a greater “FoM” for the design. A compressive modulus “E” may be defined by traditional engineering convention as the ratio of measured stress to measured strain in a material exposed to a compressive loading. High compliance ratio may result in a change in thickness for a corrugated sheet of greater than 0.05%, greater than 0.25%, greater than 1% or greater than 3% when exposed to a mechanical loading of up to 5 kgf/cm², 10 kgf/cm², 15 kgf/cm², 30 kgf/cm², 45 kgf/cm², or 100 kgf/cm².

Uniformity of load distribution over the area of the cell may be defined by comparing an exposed mechanical pressure [kgf/cm²] at any point within the area of the cell, averaged over a circular area of 10 mm² centered on said points (“point-average load measurement”). Uniformity of load distribution may then be represented using a “uniformity factor” (see Equation 3-1).

$${U}_{L} = 1 - \frac{{f}_{m a x} - {f}_{avg}}{{f}_{m a x}} \qquad Equation 3 - 1$$

Here, U_{L} is the uniformity factor, fₘₐₓ is the maximum point-average load measurement anywhere in the cell, and f_{avg} is the average load over the entire cell. A range from 0 to 1 may be possible for U_{L}, with an ideal value of 1. Therefore, a larger uniformity factor may result in a better flow field design and a greater “FoM” for the design.

A bubble evacuation measure may be defined as a time period over which a given volume within the flow field is absent of liquid reactant. An appropriate volume for this measurement may be 1 mm³, 5 mm³, or 10 mm³. An advantageous bubble evacuation period from this volume may be less than 60 minutes, less than 1 minute, less than 10 seconds, or less than 1 second. The evacuation measure may alternately be characterized as the inverse of the evacuation period resulting in an evacuation frequency, B_{f} (Hz), wherein a larger frequency is desired for stability of operation. Therefore, a larger evacuation frequency may result in a better flow field design and a greater “FoM” for the design.

Minimizing water flow resistance through a cell may be desired in order to maximize efficiency of a system to pump water through a cell or stack. Flow resistance may be characterized by the pressure loss experienced by water flow per unit length of the anode flow field (“characteristic flow resistance”—millibar per centimeter, mb/cm). The materials and geometry selected for the anode flow field, including corrugation pitch and height, material porosity and thickness, may all influence the characteristic flow resistance. Therefore, a smaller characteristic flow resistance may result in a better flow field design and a greater “FoM” for the design.

The factors described previously in reference to FIG. 3 may be formulated into an over Figure-of-Merit, “FoM”, equation as shown in Equation 3-2.

$$FoM = \frac{( \frac{{E}_{0}}{{E}_{1}} ) \cdot ( {U}_{L} ) \cdot ( {B}_{f} )}{( h ) \cdot ( Δ P )} [ Hz / mb ] \qquad Equation 3 - 2$$

Here (E₀/E₁) is the compliance ratio, U_{L} is the uniformity factor, Br is the bubble evacuation frequency [Hz], h is the total thickness [cm] of the anode flow field, and AP is the characteristic flow resistance [mb/cm] of the flow field. The resulting engineering unit for the FoM is Hz per millibar [Hz/mb], which may be interpreted as a rate of bubble removal for a given input energy. This bubble removal efficiency is then weighted by the important mechanical characteristics of compliance, load uniformity, and thickness to result in an overall FOM for the design. An advantageous FoM may be one greater than 1, greater than 5, greater than 10, or greater than 25.

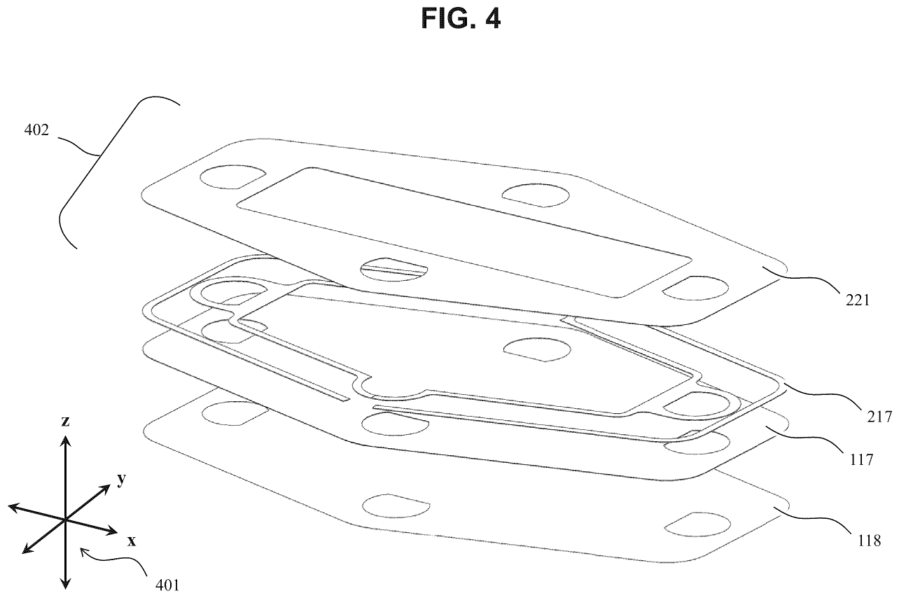

FIG. 4 shows an isometric view of a preferred embodiment bipolar plate assembly comprising a porous sheet (117) into which a hydrogen seal (217) may be embedded using a screen printing, liquid dispensing, injection, or compression molding or other suitable process. In this configuration, porous sheet (117) may provide the functionality of the cathode flow field, providing both mechanical reinforcement for hydrogen seal (217) and open space for collecting hydrogen gas flow from the active area of the cell. Porous sheet (117) may be relatively thin while also providing precise thickness control for the bipolar plate assembly during pressing and curing of hydrogen seal (217) and frame (221). Being relatively thin, porous sheet (117) may not contribute significantly to the compliance functionality desired in the overall cell and thereby place additional burden on other cell components to provide this functionality, including an anode flow field.

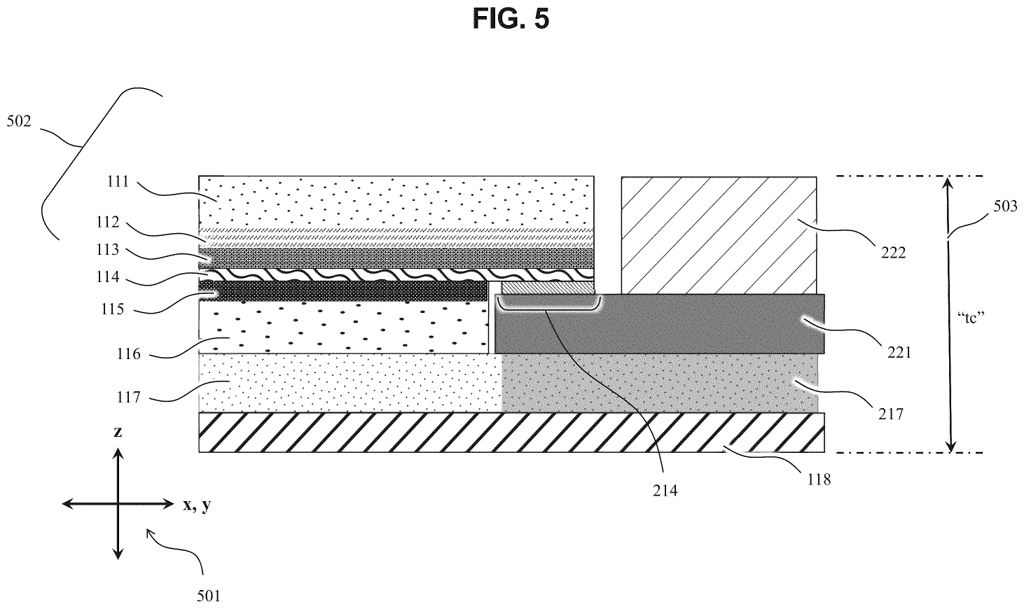

FIG. 5 illustrates a cross-section view (502) of FIG. 4 with the addition of: cathode electrode reinforcement (116), cathode electrode (115), membrane (114), anode electrode (113), anode electrode reinforcement (112), anode flow field (111), internal seal (214), and water seal (222). After assembly and curing, hydrogen seal (217) may be fully embedded within the porous structure of porous sheet (117) forming a gas tight seal for hydrogen gas within the cathode flow field while also physically adhering bipolar plate (118) to porous sheet (117) and frame (221). The porous sheet (117) may act as a reinforcement for the hydrogen seal, increasing its strength to enable sealing of high hydrogen gas pressures. Sheet (117) may be selected from one or more of a foam, a felt, a woven screen, an expanded metal, a perforated metal, or a sintered metal frit. Sheet (117) may comprise alloys of iron, steel, stainless steel, titanium, nickel, nickel-chromium, Inconel, Fecralloy, or combinations of these and may also be covered with an appropriate coating such as platinum, gold, tin, nickel, carbon, or combinations of these. Porous sheet (117) may be relatively thin, contributing to a thin overall cell thickness “tc” (503).

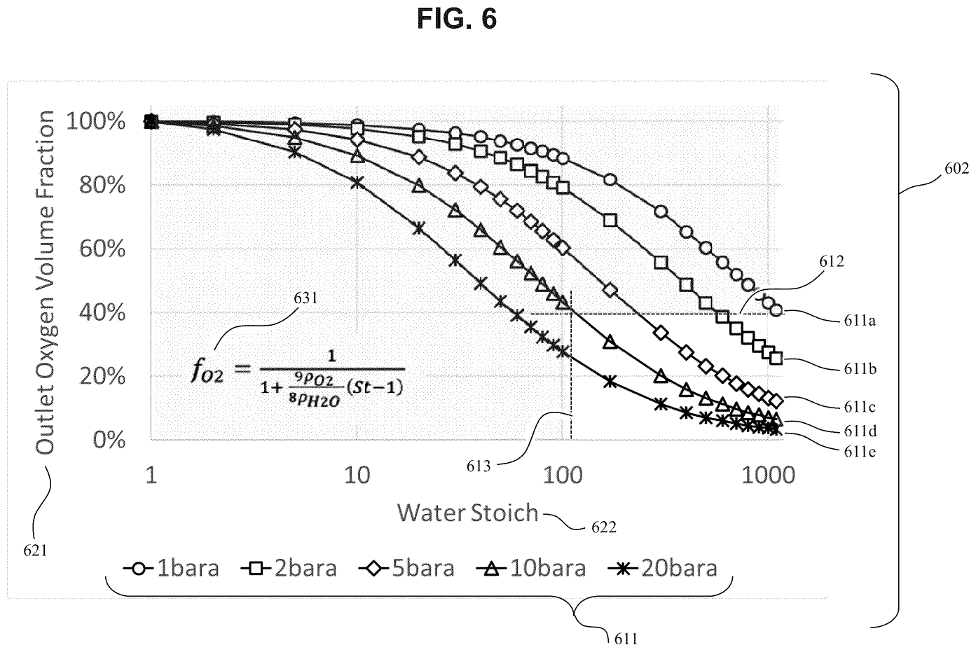

FIG. 6 shows mathematical model results for oxygen volume fraction (621) at the anode flow field outlet as a function of delivered water stoich value (622). The process of electrolysis splits water into hydrogen on the cathode side, and oxygen on the anode side. As oxygen forms on the anode, it may mix as a gas with the delivered liquid water, resulting in a two-phase flow in the anode flow field. The volume fraction of oxygen at the anode outlet may be indicative of operating stability, performance and/or durability of the electrolysis cell and a target threshold for this parameter may be set by a designer. Conserving mass for a cell may result in a formula for oxygen outlet volume fraction (631) as specified in equation 6-1. Here ρ_{O2} is the density of the oxygen gas at the anode outlet, ρ_{H2O} is the density of the liquid water at the anode outlet and St is the water stoich delivered to the cell. Plot (602) shows the results of this model at a range of anode pressures (611) for an electrolysis cell along with an illustrative oxygen volume fraction threshold (612), above which the cell may not operate stably or durably or above which an electrolysis system may not operate efficiently. The oxygen volume fraction threshold may be used to specify a lower threshold for water stoich (613). It may be advantageous to select a water stoich to maintain an oxygen volume fraction below 80%, below 60%, below 50%, below 40% or below 30% to maintain stable and durable operation of the electrolysis cell. This stoich value may be more than 50 or more than 75 or more than 100 and thereby requires careful consideration of the anode flow field geometry to ensure acceptable flow restriction can be achieved during operation. Further, as oxygen gas is produced, the volume fraction may be a function of the operating pressure (611a through e) and the bubble sizes formed may be a function of the volume fraction. Careful consideration of the flow dynamics in the anode flow field may, therefore, be important to ensuring effective removal of bubbles from the electrode and reinforcement layers and may also directly impact the operating performance and/or durability of the cell.

$${f}_{O 2} = \frac{1}{1 + \frac{9 {ρ}_{{O}_{2}}}{8 {ρ}_{{H}_{2} O}} \cdot ( St - 1 )} \qquad Equation 6 - 1$$

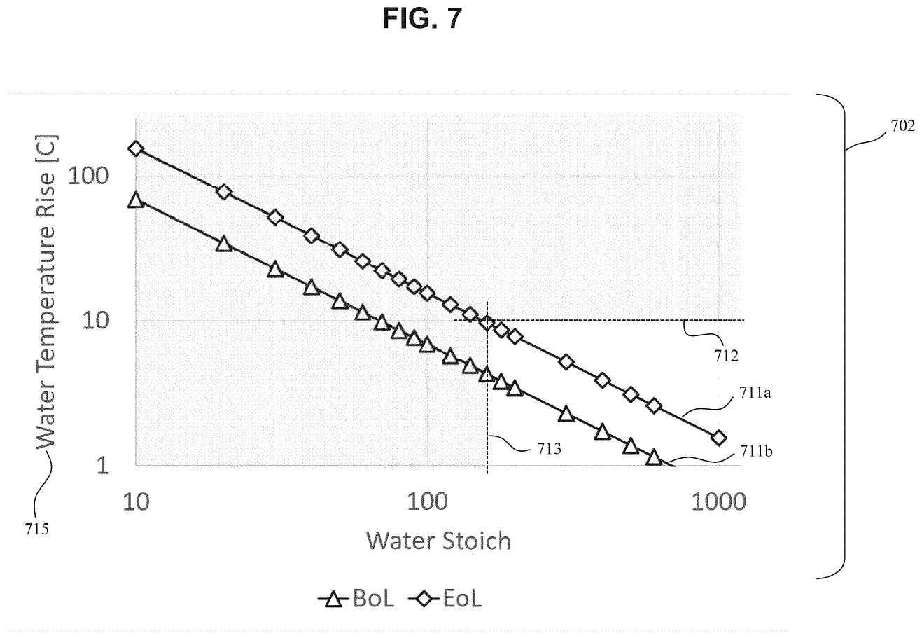

FIG. 7 shows mathematical model results for water temperature rise [° C.] as a function of delivered water stoich value. Heat released during electrolyzer operation may be a function of efficiency, which in turn, may be a function of operating cell voltage. Conserving energy for a cell may result in a formula for water temperature rise as specified in equation 7-1 (below). Here V is the operating cell voltage, Vo is the thermo-neutral cell voltage [1.481V], HHV is the higher heating value of hydrogen [141.79 MJ/kg], cₚ is the specific heat capacity of water [4.182 KJ/kg° C.] and St is the water stoich delivered to the cell. Plots (711a) and (711b) show results of this model at two possible operating voltages representing exemplary values for beginning [BoL] and end [EoL] of life for an electrolysis cell. Also shown is an illustrative water temperature rise target threshold (712), above which an electrolysis cell may not operate stably or durably or above which an electrolysis system may not operate efficiently. The temperature rise threshold may be used with an EoL voltage limit to define a lower threshold for water stoich (713). It may be advantageous to select a water stoich to maintain a water temperature rise at end of life below 100C, below 50C, below 25C, below 15C or below 10C to maintain stable and durable operation of the electrolysis cell. This stoich value may be more than 50 or more than 75 or more than 100 and thereby requires careful consideration of the anode flow field geometry to ensure acceptable flow restriction can be achieved during operation.

$$Δ T = \frac{( \frac{V}{{V}_{0}} - 1 ) \cdot HH V}{9 {c}_{p} \cdot St} \qquad Equation 7 - 1$$

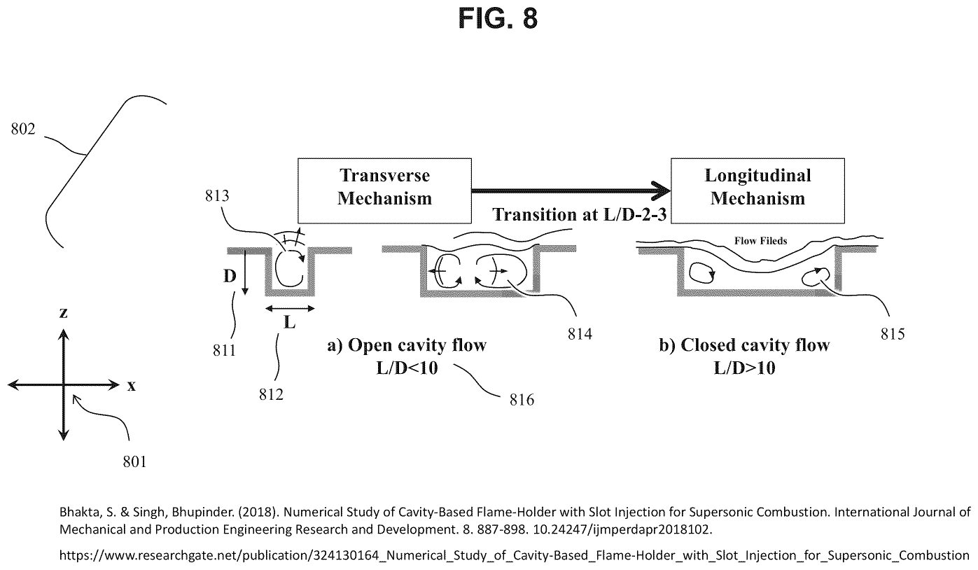

FIG. 8 shows published illustrations of flow dynamics and the formation of instabilities and flow eddies with fluid flowing over a cavity. During operation of an electrolysis cell, liquid water may be provided at the anode and oxygen gas may be evolved. It is important during this process that the oxygen gas is quickly and effectively removed from the electrode and reinforcement so additional reactant (i.e., water) can access the active sites and the reaction can continue with minimal resistance. Poor oxygen gas bubble removal, therefore, may result in poor cell performance and higher voltage or lower current than desired for operation. The anode flow field may play a significant role in the removal of gas bubbles. The geometry of the anode flow field may define fluid streamlines near the anode electrode reinforcement and generate dynamic structures such as instabilities, eddies and shear layers that may promote effective convection of bubble away from the electrode. As shown in FIG. 8 (802), fluid flow over a cavity is one method of generating such dynamical structures. Here a cavity may be defined with a depth “D” (811) and a length “L” (812). The ratio L/D (816) may be an important parameter in establishing a desired flow pattern within a cavity. As shown, an L/D of less than 10 may produce eddy patterns inside the cavity which promote fluid vortices from the bottom of the cavity to the top (813, 814). In contrast, an L/D of greater than 10 may establish smaller vortices at either side of the cavity (815) which never reach the top of the cavity. In an electrolyzer, the bottom of the cavity may represent the anode electrode reinforcement surface and the top of the cavity may represent the main water flow stream through the anode. One or more cavities may be formed by an appropriate geometry of a corrugated porous sheet, specifically configured to provide said cavities by orienting the corrugation peaks and valleys along a y-axis, perpendicular to the flow direction along an x-axis (801). It may, therefore, be advantageous to arrange the geometry of the corrugated porous sheet to mimic the geometry of the cavities illustrated (802).

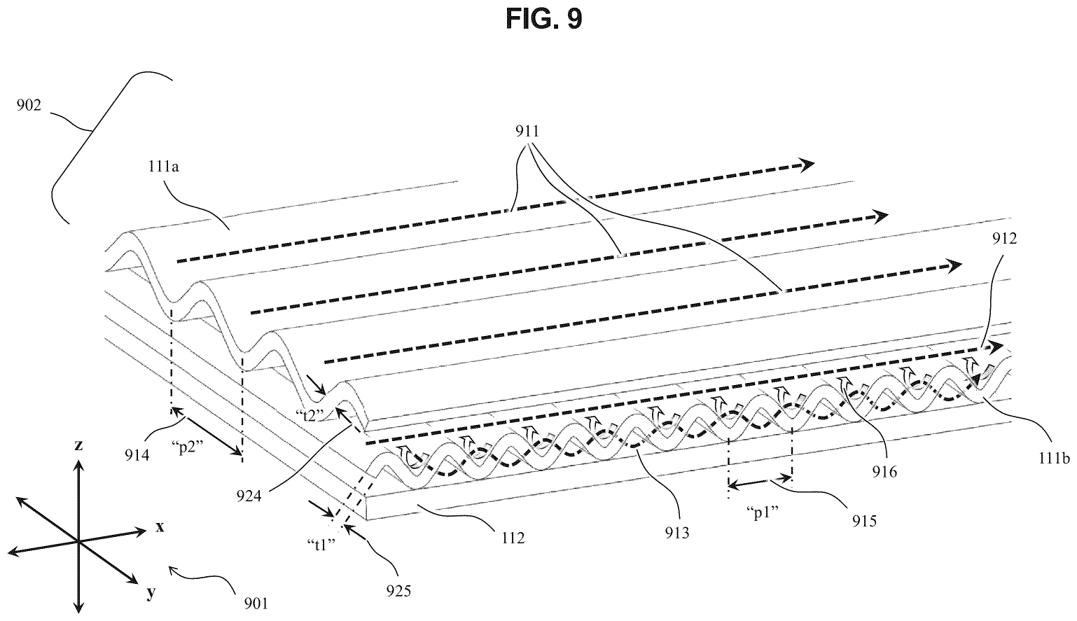

FIG. 9 shows a preferred flow arrangement (902) that may provide low water flow resistance in an anode flow field (111a, 111b) while simultaneously generating instability and eddies (913, 916) near the electrode reinforcement layer (112) for promoting convection of gas bubbles away from the electrode. As shown the anode flow field consists of two corrugated layers. One layer (111b) is positioned nearest to the anode electrode reinforcement and oriented with its peaks and valleys oriented along a y-axis (901), substantially perpendicular to the water flow through the cell (911). This first layer may have a peak-to-peak pitch “p1” (915) and be formed from a porous sheet with a thickness “t1” (925). A second layer (111a) is positioned furthest from the anode electrode reinforcement and oriented with its peaks and valleys oriented along an x-axis (901) substantially parallel with the water flow through the cell (911). This second layer may have a peak-to-peak pitch “p2” (914) and be formed from a porous sheet with a thickness “t2” (924). As both sheets are porous, liquid and gas may be free to move along any of the three axes within the space defined by the two layers. Most of the water flow may run along relatively straight streamlines either above (911) or below (912) the second layer (111a). The streamline below the second layer (111a) may act like the flow running over a cavity described in FIG. 8. In this case the cavity may be generally defined by the corrugation pattern of first layer (111b), which may induce flow instability (913) and convective eddies (916) which may promote the effective transport of gas bubbles from the electrode reinforcement layer (112) into the main flow stream (912). As described with FIG. 8, it may be advantageous to configure layer 1 (111b) with a cavity ratio L/D (816) of less than 10 or less than 5 or less than 2.5 to maximize the effectiveness for the removal of gas bubbles. The one or more porous layers of anode flow field (111) may be selected from one or more of a foam, a felt, a woven screen, an expanded metal, a perforated metal, or a sintered metal frit. The porous materials used for (111) may comprise alloys of iron, steel, stainless steel, titanium, nickel, nickel-chromium, Inconel, Fecralloy, or combinations of these and may also be covered with an appropriate coating such as platinum, gold, tin, nickel, carbon, or combinations of these. The porous layers may be processed prior to corrugating (e.g., by calendaring between rollers) to achieve a desired thickness (“t1”, “t2”) and/or to achieve desired mechanical properties such as yield strength, hardness or elasticity.

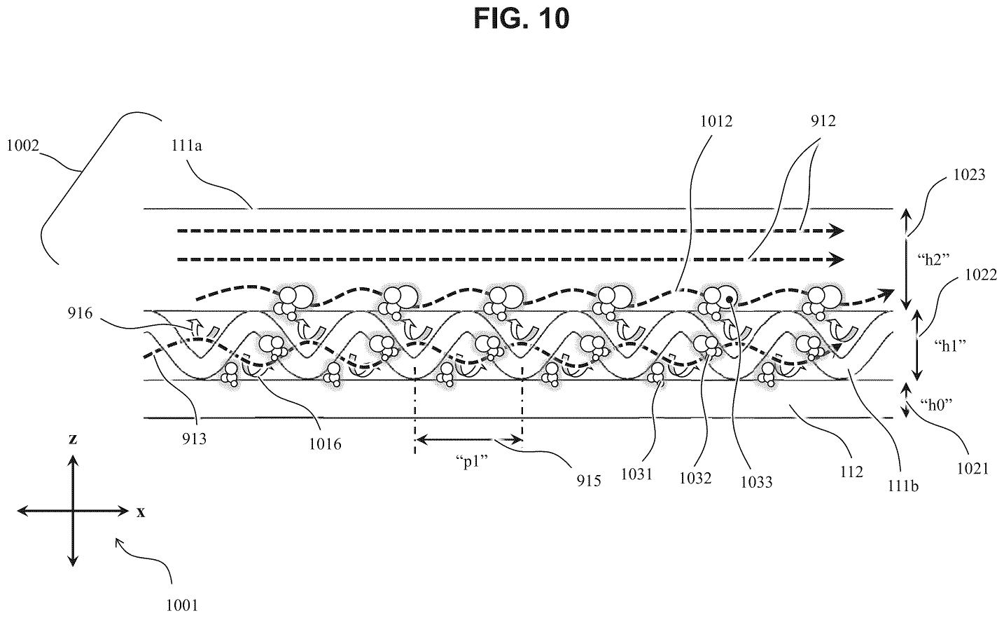

FIG. 10 shows a cross-sectional view (1002) of FIG. 9 (902), further illustrating potential fluid dynamical structures that may be created by the present invention. In this illustration, gas bubbles (1031) emerging from the electrode reinforcement layer (112) are moved away by convection of eddies (1016) along a z-axis (1001). The bubbles (1032) may then move through layer 1 (111b) and be moved further away by convection of eddies (916) along a z-axis. Bubbles (1033) may finally enter the main water flow (912) for removal from the cell. The corrugated structure of layer 1 (111b), with peaks and valleys perpendicular to the main flow of water (112) may promote the generation of oscillatory streamlines (913) which flow through the porous structure of layer 1 (111b). This configuration of layer 1 (111b) may further promote the generation of oscillatory streamlines (1012) adjacent to the porous structure. The net result of the combination of oscillatory streamlines may be to create instabilities that dislodge bubbles stuck to the electrode reinforcement (112) or the layers themselves (111b, 111a) so they may be transported by convection into the main water flow stream (912) via the aforementioned dynamical structures. It may be advantageous to configure layer 1 (111b) with a ratio of height “h1” (1022) to pitch “p1” (915) to mimic a ratio of less than 10 or less than 5 or less than 2.5, which may promote preferred dynamical patterns as described in FIG. 8 (816). With corrugations aligned along a y-axis, perpendicular to the flow streamlines (912), layer 1 (111b) may present greater fluid flow resistance than layer 2 (111a), with corrugations aligned along an x-axis, parallel to said streamlines. It may therefore be advantageous for minimizing overall flow resistance through the anode flow field to configure layer 2 (111a) with a height “h2” (1023) greater than or equal to that of layer 1 (“h1”, 1022), resulting in a preferred ratio h2/h1≥1.

FIGS. 11A, 11B, and 11C show an Illustration of the dimensional response for a preferred embodiment of the present invention to an externally applied compressive load [kgf] (1111) oriented along a z-axis. FIG. 11A illustrates the dimensions prior to load application; FIG. 11B illustrates the dimensions during load application; FIG. 11C illustrates the dimensions after load application. Elastic response may be defined as the anode flow field returning to within 0.5% of its original height (“h1”+“h2”) when the exposed load is removed. Elastic response may be further defined as a corrugated porous sheet that can withstand an applied compressive load of at least 20 kilograms-force per square centimeter without permanent deformation when applied along a z-axis. Compliance may be defined as the inverse of an effective elastic spring constant along a z-axis (i.e., change in “z” [mm] per unit of applied force [kgf]). The greater the compliance, the greater the elastic change in thickness for a given applied load, and the more like a spring the component will act. Preferred compliance of the anode flow field may be defined such that its height (“h1”+“h2”) is reduced from between 3% and 15% when exposed to a load of between 10 and 100 kilograms-force per square centimeter. The height “h0” (1021) of the electrode reinforcement layer (112) is relatively thin and may be stiff (i.e., non-compliant) relative to the other layers shown. The height “h0” may therefore not change significantly with the addition of load (1111). Due to the geometry and materials properties of corrugated layers 1 (111b), and 2 (111a), their respective heights “h1a” (1022) and “h2a” (1023) may be significantly changed (“h1b”, 1122 and “h2b”, 1123) by application of load (1111). Furthermore, material properties, including yield strength, hardness or elasticity, and geometry, including thicknesses “t1” (925) and “t2” (924), of the corrugated structures (111b, 111a) may be configured such that they respond elastically to the application of load, such that when the load is removed, the respective heights of each layer return generally to their original values within +5% (“h1c”, 1132 and “h2c”, 1133). Uniform distribution of compressive loading (1111) onto the active area of the cell may be important for effective operation of the cell. Therefore, uniform distribution of applied loading through layer 2 (111a), layer 1 (111b) and the electrode reinforcement (112) may be advantaged by the selection of geometry (e.g., thicknesses “t”, heights “h” and pitches “p”) for these layers. It may be important to minimize bending of each layer in an x-y plane to accomplish this goal. As bending in such structures may be significantly influenced by an unsupported length of a layer relative to that layer's height, it may be advantageous to limit the ratio of said unsupported length to the height of each layer in the cell. For instance, the pitch “p1” of layer 1 (111b) defines an unsupported length for the electrode reinforcement layer (112), which has height “h0” (1021). It may be advantageous to limit the ratio p1/h0≤10, or p1/h0≤5, or p1/h0≤2.5. Likewise, the pitch “p2” (914, FIG. 9) of layer 2 (111a) defines an unsupported length for layer 1 (111b), which has height “h1” (1022, FIG. 10). It may be advantageous to limit the ratio p2/h1≤10, or p2/h1≤5, or p2/h1≤2.5. As compliance within layers 1 (111b) and 2 (111a) are desired, flexing of the corrugation peaks and valleys are necessary. This flexing may be substantially controlled by geometry and material properties of the layer. In particular, the thickness of the porous layers (“t”, 925, 924) relative to the corrugation dimensions (“h” and “p”) may significantly impact the overall compliance once formed into a corrugated structure. It may be advantageous to limit the ratio p1/t1≤15, or p1/t1≤10, or p1/t1≤5. It may be advantageous to limit the ratio p2/t2≤15, or p2/t2≤10, or p2/t2≤5. It may be advantageous to limit the ratio h1/t1≤10, or h1/t1≤5, or h1/t1≤2.5. It may be advantageous to limit the ratio h2/t2≤10, or h2/t2≤5, or h2/t2≤2.5.

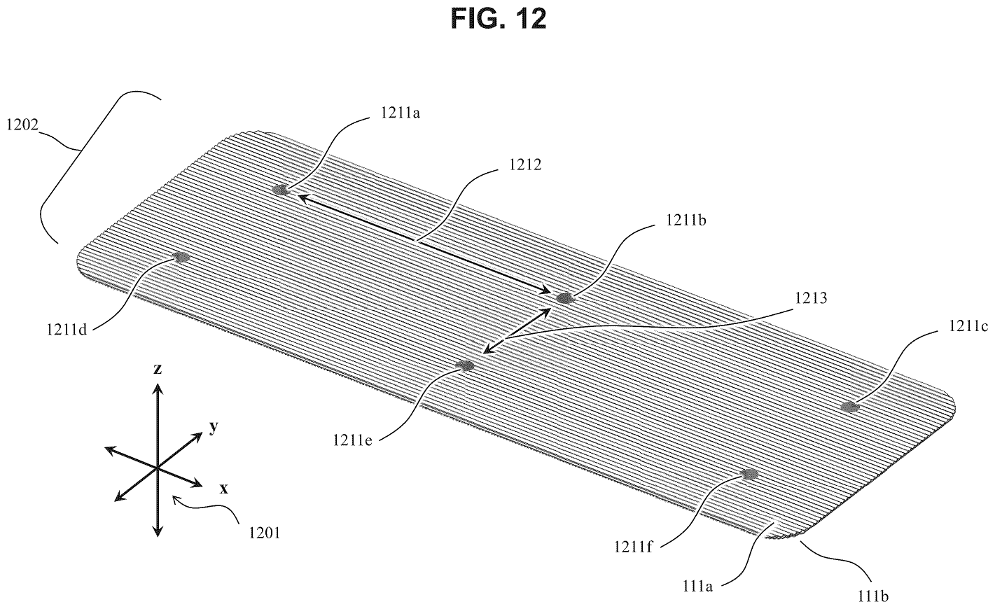

FIG. 12 shows a flow field (1202) wherein two layers (111a, 111b) may be bonded at several spots (1211a through 1211f) to facilitate alignment and handling as a unitized component with multiple layers. More than two layers may be bonded in this way. Bonding points may be distributed over the surface of the layers in an x-y plane (1201) with spacing along an x-axis (1212) and spacing along a y-axis (1213). Spacing along the different axes may be the same or different. The quantity of bonding points (1211a-1211f) along the different axes may be different. Bonding may be accomplished by welding, brazing, diffusion bonding, adhesive bonding, or any other known method.

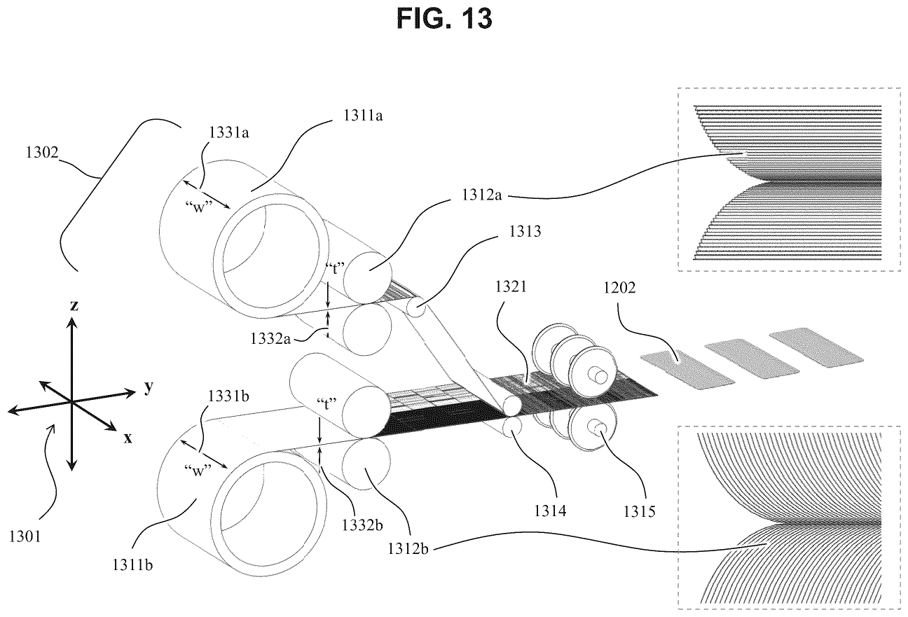

FIG. 13 shows a preferred embodiment of a system (1302) for continuous, high speed manufacturing of the anode flow field of FIG. 12. Two coils of porous materials (1311a, 1311b) may be mounted at the beginning of the process with the coil axes aligned with an x-axis. The two materials may be the same or different and may be pre-processed to achieve a desired thickness “t” (1332a, 1332b). The web width “w” (1331a) of coil (1311a) and the web width “w” (1331b) of coil (1311b) may be equal within ±5%. The web from coil (1311a) may be directed through forming rollers (1312a) which may have forming teeth oriented parallel to the roller's axis to emboss a corrugated pattern into the web material thereby increasing its dimension long a z-axis. The corrugated pattern for coil (1311a) may be oriented with peaks and valleys aligned substantially with an x-axis. The web from coil (1311b) may be directed through forming rollers (1312b) which may have forming teeth oriented substantially circumferentially around the roller to emboss a corrugated pattern into the web material thereby increasing its dimension long a z-axis. The corrugated pattern for coil (1311b) may be oriented with peaks and valleys aligned substantially with a y-axis. The corrugated patterns for each coil may be substantially the same or different. The corrugated web (1311a) may then be passed over roller (1313) to direct it toward corrugated web (1311b) where both webs may be brought adjacent to each other through rollers (1314). The two layer web (1321) may then be passed between welding rollers (1315) positioned on both sides of the two layer web. Welding rollers (1315) may be connected to an AC or DC power supply configured to weld the two layers into a unitized web as described in FIG. 12. Welding may be continuous or periodic thereby producing discrete spot welds as shown in FIG. 12. The spacing along an x-axis (1212) may be determined by the spacing of the wheels on rollers (1315). The spacing along a y-axis (1213) may be determined by the period [seconds] of the welding pulses delivered to the welding rollers divided by the speed [cm/second] of the moving web along a y-axis. The number of welding wheels on the rollers and the period of the welding pulses may be determined to ensure an adequate bond between the layers. More than two layers may also be processed in this way. After welding, the unitized web may be cut into discrete piece parts (1202) using known cutting methods capable of cutting the multiple layers of porous material. Such methods may include laser cutting, die stamping, roller die cutting, water jet cutting, shearing, slitting, or any other known method.

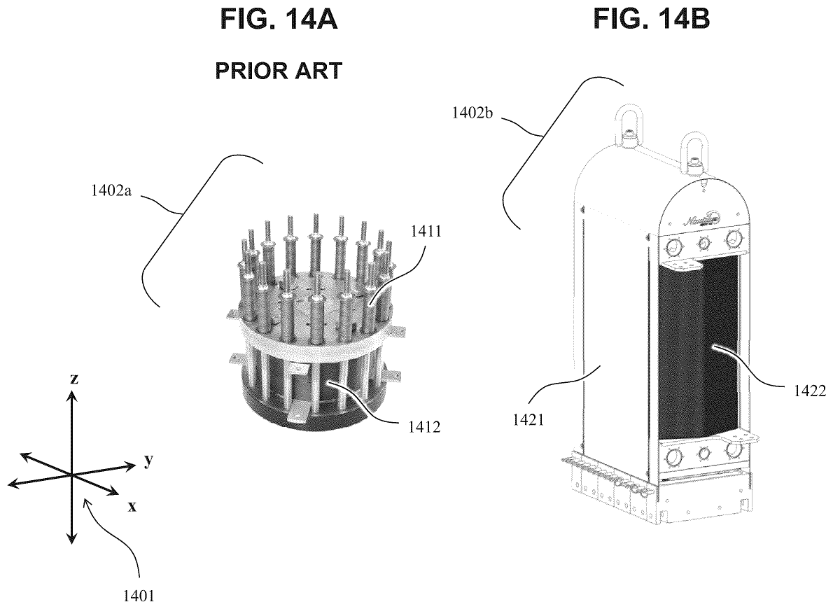

FIGS. 14A and 14B show a prior art stack (1402a) and a stack including elements of preferred embodiments of the present disclosure (1402b). Prior art stack (1402a) requires many, large springs (1411) to maintain compressive load on the core cells (1412) in the stack. These springs may take up considerable volume, consist of many parts, and may be inefficient or inconvenient to assemble during stack production. Alternatively, stack (1402b) does not require large external spring and compression may be implemented using a simple wrap (1421) of thin sheets. Wrap (1421) may provide minimal spring function for compressing the stack. Compressive load may therefore be maintained by virtue of the compliance inherent in the core cells (1422) in the stack. Said compliance may be afforded to the cells by the flow fields disclosed in various embodiments of the present disclosure. In particular, an anode flow field (111) may be configured with substantial compliance along a z-axis and may thereby facilitate maintenance of compression over time and during changes in temperature, pressure or other process condition the stack may be exposed to in combination with a stack compression wrap (1421) with minimal compliance. The anode flow field may further provide the necessary compliance within the core cells (1422) in a stack when combined with a relatively thin cathode flow field (117) with minimal compliance and thereby enable mechanical functionality of relatively thin cells. Cells with a total thickness of tc≤5.0 mm, or tc≤3.0 mm, or tc≤2.5 mm may be enabled by preferred embodiments of the present disclosure.

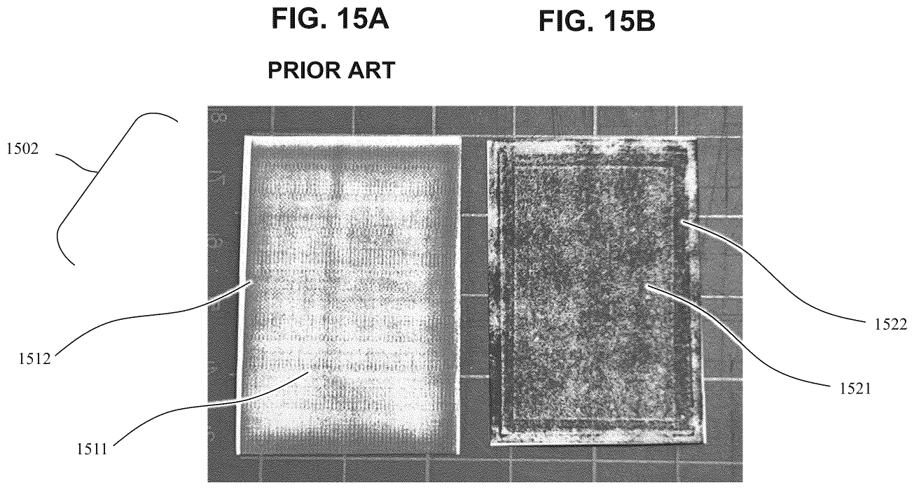

FIGS. 15A and 15B show pressure paper test results quantifying compressive loading uniformity in the active area of an electrolysis cell comparing a prior art anode flow field (FIG. 15A) and a preferred embodiment of the present disclosure (FIG. 15B). The assembly of FIG. 15A comprised an anode flow field comprising three layers of flat, stainless steel wire mesh. The assembly of FIG. 15B comprised an anode flow field comprising one layer of flat, stainless steel wire mesh combined with one layer of stainless steel wire mesh corrugated with a geometry consistent with the present disclosure. Although the overall flow field and cell thicknesses in both tests were the same, the lack of compliance in the prior art assembly is obvious from the highly non-uniform pressure (1511) exposed to the active area relative to the border area (1512) of the cell. In contrast, the compliance inherent in the preferred embodiment assembly enables the loading in both the active (1521) and border (1522) areas of the cell to be substantially equal. This result confirms the advantages of a compliant flow field structure in achieving more uniform load distribution for thin electrolysis cells.

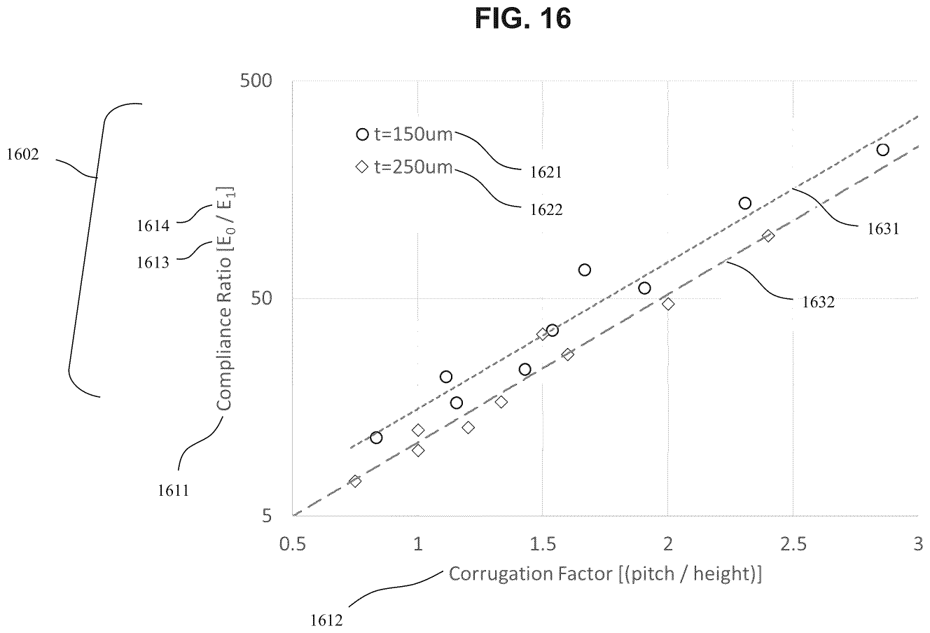

FIG. 16 shows the results (1602) of finite element simulations computed for a series of exemplary corrugated porous sheet geometries. A compressive modulus “E” may be defined by traditional engineering convention as the ratio of measured stress to measured strain in a material exposed to a compressive loading. A compressive modulus “E.” (1613), typical of an un-corrugated stainless steel woven wire mesh of two different thicknesses was used: 150 μm (1621) and 250 μm (1622). An external load of 30 kgf/cm² was applied to models of varying corrugation pitch-to-height ratios (1612). The resulting calculated deflection was converted into a compressive modulus “E₁” (1614). The ratio compliance ratio E₀/E₁ (1611) was then plotted vs. the pitch-to-height ratio (1612) resulting in data (1621, 1622) for the two thicknesses, respectively. Least-squares curve fits for the two data sets (1631, 1632) illustrate that the compliance ratio may be significantly impacted by choice of pitch-to-height ratio and compliance ratio values greater than 2, 5, 10, 25 or 100 may be achieved. Compliance ratios of these magnitudes may provide advantageous compressive load distribution over a cell area (as shown in FIG. 15) and may further provide for advantageous simplification of requirements for the design of external cell and stack mechanical compression systems. High compliance ratio may result in a change in thickness for a corrugated sheet of greater than 0.05%, greater than 0.25%, greater than 1% or greater than 3% when exposed to a mechanical loading of up to 5 kgf/cm², 10 kgf/cm², 15 kgf/cm², 30 kgf/cm², 45 kgf/cm², or 100 kgf/cm².

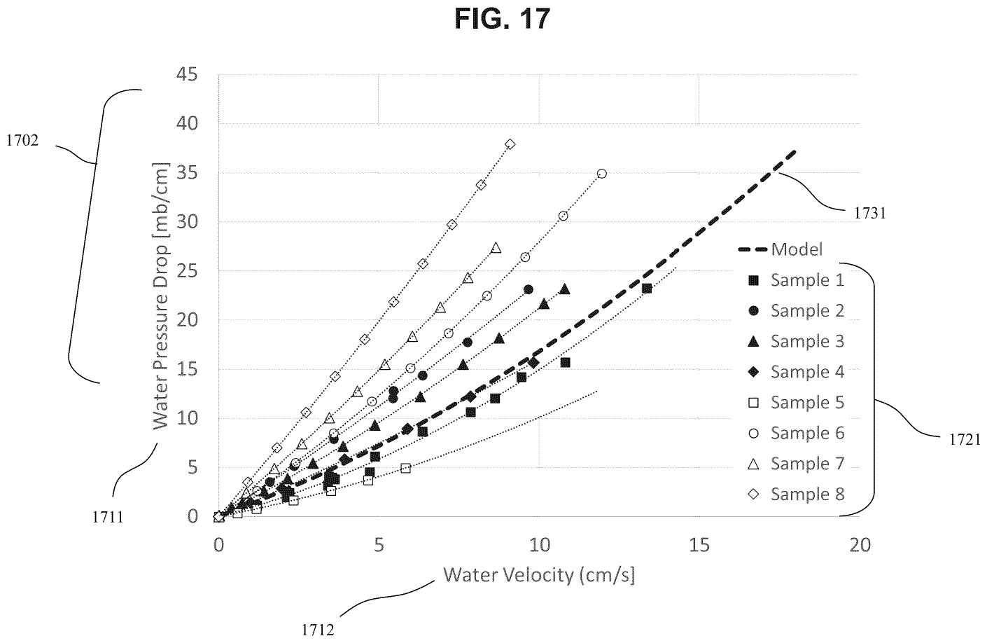

FIG. 17 (1702) shows the characteristic flow resistance [millibar per centimeter, mb/cm] (1711) vs. water flow velocity [centimeters per second, cm/s] (1712) measured for a number of exemplary flow fields (1721). Also shown are mathematical model results (1731) for an exemplary flow field. Anode flow fields exhibiting characteristic flow resistance vs. flow velocity curves of these magnitudes may be advantageous for minimizing pumping energy consumed by a system employing stacks of cells comprising flow fields with these characteristics.

### EXEMPLARY EMBODIMENTS

A. An electrolysis cell comprising: a membrane, an anode, a cathode, an anode reinforcement layer, a cathode reinforcement layer an anode flow field, a cathode flow field, and a bipolar plate assembly, wherein the anode flow field comprises one or more porous sheets having at least one straight edge, and wherein at least one of the porous sheets has the form of a corrugated pattern with a plurality of peaks and valleys whose axes are generally aligned with one straight edge of the sheet and which protrude a height “h” along a z-axis which is generally aligned with the thickness dimension of said sheet.

B. The electrolysis cell of A, wherein the anode flow field is configured such that its thickness is reduced from between 3% and 15% when exposed to a load of between 10 and 100 kilograms-force per square centimeter, and wherein the anode flow field returns to within 0.5% of its original thickness when the exposed load is removed.

C. The electrolysis cell of A, wherein the at least one corrugated porous sheet can withstand an applied compressive load of at least 20 kilograms-force per square centimeter without permanent deformation when applied along a z-axis generally aligned with the thickness of the sheet.

D. The electrolysis cell of A, wherein the one or more porous sheets are calendered to a thickness selected to achieve a target yield strength, hardness or elastic modulus.

E. The electrolysis cell of A, wherein the anode flow field comprises two or more porous sheets, and wherein the two or more porous sheets are spot welded to form a single flow field structure.

F. The electrolysis cell of A, wherein the anode flow field comprises a corrugated, porous sheet adjacent to the anode reinforcement layer, and wherein the ratio of the corrugation pitch “p1” of the porous sheet to the height “h0” of the anode reinforcement layer is less than 10, less than 5, or less than 2.5.

G. The electrolysis cell of A, wherein the anode flow field comprises exactly two corrugated, porous sheets, and wherein the ratio of the corrugation pitch “p2” of the sheet farthest from the anode electrode to the height “h1” of the sheet nearest to the electrode is less than 10, less than 5, or less than 2.5.

H. The electrolysis cell of A, wherein the anode flow field comprises at least one corrugated, porous sheet, and wherein the ratio of corrugation pitch to sheet thickness p/t≤15, or p/t≤10, or p/t≤5.

I. The electrolysis cell of A, wherein the anode flow field comprises at least one corrugated, porous sheet, and wherein the ratio of corrugation height to sheet thickness h/t≤10, or h/t≤5, or h/t≤2.5.

J. The electrolysis cell of A, wherein the anode flow field comprises exactly two corrugated, porous sheets, and wherein the corrugation pitch “p1” of the sheet nearest to the anode electrode is between 0.4 mm and 2.0 mm, and wherein the corrugation pitch “p2” of the sheet farthest from the anode electrode is between 0.5 mm and 2.5 mm

K. The electrolysis cell of A, wherein the anode flow field comprises exactly two corrugated, porous sheets, and wherein the height “h1” of the sheet nearest to the anode electrode is between 0.1 mm and 1.0 mm, and wherein the height “h2” of the sheet farthest from the anode electrode is between 0.2 mm and 2.0 mm

L. The electrolysis cell of A, wherein the anode flow field comprises exactly two corrugated, porous sheets, and wherein the corrugation pitch “p1” of the sheet nearest to the anode electrode is less than or equal to the corrugation pitch “p2” of the sheet furthest from the anode electrode.

M. The electrolysis cell of A, wherein the anode flow field comprises exactly two corrugated, porous sheets, and wherein the height “h1” of the sheet nearest to the anode electrode is less than or equal to the height “h2” of the sheet furthest from the anode electrode.

N. The electrolysis cell of A, wherein the anode flow field comprises exactly two corrugated, porous sheets, and wherein the sheet positioned furthest from the anode electrode is oriented with the axes of its peaks and valleys generally parallel to the flow direction of the anode reactant.

O. The electrolysis cell of A, wherein the anode flow field comprises exactly two corrugated, porous sheets, and wherein the sheet positioned nearest to the anode electrode is oriented with the axes of its peaks and valleys generally perpendicular to the flow direction of the anode reactant.

P. The electrolysis cell of A, wherein the one or more porous sheets are all corrugated, and wherein the corrugation peaks of adjacent sheets are oriented generally perpendicular to each other.

Q. The electrolysis cell of A, wherein the one or more porous sheets are selected from one or more of a stainless steel, a titanium, a nickel, or a nickel-chromium material.

R. The electrolysis cell of A, wherein the one or more porous sheets are selected from one or more of a wire mesh, an expanded foil or perforated sheet.

S. The electrolysis cell of A, wherein the cathode flow field comprises a porous sheet containing an embedded hydrogen seal such that the porous sheet provides both mechanical reinforcement for the embedded hydrogen seal and an open space for hydrogen gas flow from an active area of the electrolysis cell to an exit of the cell.

T. An electrolyzer stack containing one or more electrolysis cells each comprising: a membrane, an anode, a cathode, an anode reinforcement layer, a cathode reinforcement layer an anode flow field, a cathode flow field, and a bipolar plate assembly, wherein the anode flow field comprises one or more porous sheets having at least one straight edge, and wherein at least one of the porous sheets has the form of a corrugated pattern with a plurality of peaks and valleys whose axes are generally aligned with one straight edge of the sheet and which protrude a height “h” along a z-axis which is generally aligned with the thickness dimension of said sheet, and wherein the stack comprises a compression system comprising: a structural wrap comprising one or more wrap layers circumferentially surrounding at least a portion of an electrolyzer cell stack containing a plurality of cells

U. The electrolysis stack of T, wherein the anode flow field is configured such that its thickness is reduced from between 3% and 15% when exposed to a load of between 10 and 100 kilograms-force per square centimeter, and wherein the anode flow field returns to within 0.5% of its original thickness when the exposed load is removed.

V. The electrolysis stack of T, wherein the at least one corrugated porous sheet can withstand an applied compressive load of at least 20 kilograms-force per square centimeter without permanent deformation when applied along a z-axis generally aligned with the thickness of the sheet.

W. The electrolysis stack of T, wherein the anode flow field comprises a corrugated, porous sheet adjacent to the anode reinforcement layer, and wherein the ratio of the corrugation pitch “p1” of the porous sheet to the height “h0” of the anode reinforcement layer is less than 10, less than 5, or less than 2.5.

X. The electrolysis stack of T, wherein the anode flow field comprises exactly two corrugated, porous sheets, and wherein the ratio of the corrugation pitch “p2” of the sheet farthest from the anode electrode to the height “h1” of the sheet nearest to the electrode is less than 10, less than 5, or less than 2.5.

Y. The electrolysis stack of T, wherein the anode flow field comprises exactly two corrugated, porous sheets, and wherein the average thickness of the cells in the stack core is less than 5 mm, less than 3 mm, or less than 2.5 mm.

Z. The electrolysis stack of T, wherein the structural wrap serves as a tensile element of the compression system, and wherein the one or more wrap layers are essentially flat sheets of material having an essentially uniform thickness.

AA. The electrolysis stack of T, wherein a total thickness of the one or more wrap layers is determined by an x-axis dimension of the cell stack and the maximum allowable working pressure of the electrolyzer cell stack.

BB. A method of operating and electrolysis cell, wherein the reactants entering the anode flow field comprise liquid water containing no more than 1% by weight of elements other than hydrogen and oxygen, and wherein the products exiting the cathode flow field have a non-zero vapor phase moisture content, and wherein the anode flow field comprises one or more porous sheets having at least one straight edge, and wherein at least one of the porous sheets has the form of a corrugated pattern with a plurality of peaks and valleys whose axes are generally aligned with one straight edge of the sheet and which protrude a height “h” along a z-axis which is generally aligned with the thickness dimension of said sheet.

CC. A method of fabricating an anode flow field for an electrolysis cell, wherein a continuous process of corrugation and lamination is performed, wherein the web from one coil of flat, porous material (“web1”) is directed through a pair of rollers configured to corrugate said web with a plurality of peaks and valleys with a corrugation pitch of “p1”, and wherein the axes of the corrugations of “web1” are generally aligned with the axis of the coil, and wherein the height “h1” of the corrugations of “web1” extend along a z-axis which is generally aligned with the thickness dimension of “web1”, and wherein the web from a second coil of flat, porous material (“web2”) is directed through a pair of rollers configured to corrugate said web with a plurality of peaks and valleys with a corrugation pitch of “p2”, and wherein the axes of the corrugations of “web2” are generally aligned with the uncoiling direction of “web2”, and wherein the height “h2” of the corrugations of “web2” extend along a z-axis which is generally aligned with the thickness dimension of “web2”, and wherein after passing through the corrugation rollers, “web1” and “web2” are brought adjacent to each other, and wherein the two layers are spot welded to each other periodically across the web width and along the uncoiling direction length, and wherein discrete anode flow field components are cut from the laminated web by laser cutting, roller-die cutting or punching.

What is claimed is:

1. An electrolysis cell comprising:
a membrane,
an anode,
a cathode,
an anode reinforcement layer,
a cathode reinforcement layer
an anode flow field,
a cathode flow field,
and a bipolar plate assembly,
wherein the anode flow field comprises one or more porous sheets having at least one straight edge, and
wherein at least one of the porous sheets has the form of a corrugated pattern with a plurality of peaks and valleys whose axes are generally aligned with one straight edge of the sheet and which protrude a height “h” along a z-axis which is generally aligned with the thickness dimension of said sheet.

2. The electrolysis cell of claim 1,
wherein the anode flow field is configured such that its thickness is reduced from between 0.05% and 5% when exposed to a load of between 10 and 100 kilograms-force per square centimeter, and
wherein the anode flow field returns to within 0.05% of its original thickness when the exposed load is removed.

3. The electrolysis cell of claim 1,
wherein the at least one corrugated porous sheet can withstand an applied compressive load of at least 20 kilograms-force per square centimeter without permanent deformation when applied along a z-axis generally aligned with the thickness of the sheet.

4. The electrolysis cell of claim 1,
wherein the one or more porous sheets are calendered to a thickness selected to achieve a target yield strength, hardness, or elastic modulus.

5. The electrolysis cell of claim 1,
wherein the anode flow field comprises two or more porous sheets, and
wherein the two or more porous sheets are spot welded to form a single flow field structure.

6. The electrolysis cell of claim 1,
wherein the anode flow field comprises a corrugated, porous sheet adjacent to the anode reinforcement layer, and
wherein the ratio of the corrugation pitch “p1” of the porous sheet to the height “h0” of the anode reinforcement layer is less than 10, less than 5, or less than 2.5.

7. The electrolysis cell of claim 1,
wherein the anode flow field comprises exactly two corrugated, porous sheets, and
wherein the ratio of the corrugation pitch “p2” of the sheet farthest from the anode electrode to the height “h1” of the sheet nearest to the electrode is less than 10, less than 5, or less than 2.5.

8. The electrolysis cell of claim 1,
wherein the anode flow field comprises at least one corrugated, porous sheet, and
wherein the ratio of corrugation pitch “p” to sheet thickness “t” is less than 15, less than 10, or less than 5.

9. The electrolysis cell of claim 1,
wherein the anode flow field comprises at least one corrugated, porous sheet, and
wherein the ratio of corrugation height “h” to sheet thickness “t” is less than 10, less than 5, or less than 2.5.

10. The electrolysis cell of claim 1,
wherein the anode flow field comprises exactly two corrugated, porous sheets, and
wherein the corrugation pitch “p1” of the sheet nearest to the anode electrode is between 0.2 mm and 2.0 mm, and
wherein the corrugation pitch “p2” of the sheet farthest from the anode electrode is between 0.25 mm and 2.5 mm.

11. The electrolysis cell of claim 1,
wherein the anode flow field comprises exactly two corrugated, porous sheets, and
wherein the height “h1” of the sheet nearest to the anode electrode is between 0.1 mm and 1.0 mm, and
wherein the height “h2” of the sheet farthest from the anode electrode is between 0.2 mm and 2.0 mm.

12. The electrolysis cell of claim 1,
wherein the anode flow field comprises exactly two corrugated, porous sheets, and
wherein the corrugation pitch “p1” of the sheet nearest to the anode electrode is less than or equal to the corrugation pitch “p2” of the sheet furthest from the anode electrode.

13. The electrolysis cell of claim 1,
wherein the anode flow field comprises exactly two corrugated, porous sheets, and
wherein the height “h1” of the sheet nearest to the anode electrode is less than or equal to the height “h2” of the sheet furthest from the anode electrode.

14. The electrolysis cell of claim 1,
wherein the anode flow field comprises exactly two corrugated, porous sheets, and
wherein the sheet positioned furthest from the anode electrode is oriented with the axes of its peaks and valleys generally parallel to the flow direction of the anode reactant.

15. The electrolysis cell of claim 1,
wherein the anode flow field comprises exactly two corrugated, porous sheets, and
wherein the sheet positioned nearest to the anode electrode is oriented with the axes of its peaks and valleys generally perpendicular to the flow direction of the anode reactant.

16. The electrolysis cell of claim 1,
wherein the one or more porous sheets are all corrugated, and
wherein the corrugation peaks of adjacent sheets are oriented generally perpendicular to each other.

17. The electrolysis cell of claim 1,
wherein the one or more porous sheets are selected from one or more of a stainless steel, a titanium, a nickel, or a nickel-chromium material.

18. The electrolysis cell of claim 1,
wherein the one or more porous sheets are selected from one or more of a wire mesh, an expanded foil or perforated sheet.

19. The electrolysis cell of claim 1,
wherein the cathode flow field comprises a porous sheet containing an embedded hydrogen seal such that the porous sheet provides both mechanical reinforcement for the embedded hydrogen seal and an open space for hydrogen gas flow from an active area of the electrolysis cell to an exit of the cell.

20. An electrolyzer stack containing one or more electrolysis cells each comprising:
a membrane,
an anode,
a cathode,
an anode reinforcement layer,
a cathode reinforcement layer
an anode flow field,
a cathode flow field,
and a bipolar plate assembly,
wherein the anode flow field comprises one or more porous sheets having at least one straight edge, and
wherein at least one of the porous sheets has the form of a corrugated pattern with a plurality of peaks and valleys whose axes are generally aligned with one straight edge of the sheet and which protrude a height “h” along a z-axis which is generally aligned with the thickness dimension of said sheet, and
wherein the stack comprises a compression system comprising:
a structural wrap comprising one or more wrap layers circumferentially surrounding at least a portion of an electrolyzer cell stack containing a plurality of cells.

21. The electrolysis stack of claim 20,
wherein the anode flow field is configured such that its thickness is reduced from between 0.05% and 5% when exposed to a load of between 10 and 100 kilograms-force per square centimeter, and
wherein the anode flow field returns to within 0.05% of its original thickness when the exposed load is removed.

22. The electrolysis stack of claim 20,
wherein the at least one corrugated porous sheet can withstand an applied compressive load of at least 20 kilograms-force per square centimeter without permanent deformation when applied along a z-axis generally aligned with the thickness of the sheet.

23. The electrolysis stack of claim 20,
wherein the anode flow field comprises a corrugated, porous sheet adjacent to the anode reinforcement layer, and
wherein the ratio of the corrugation pitch “p1” of the porous sheet to the height “h0” of the anode reinforcement layer is less than 10, less than 5, or less than 2.5.

24. The electrolysis stack of claim 20,
wherein the anode flow field comprises exactly two corrugated, porous sheets, and
wherein the ratio of the corrugation pitch “p2” of the sheet farthest from the anode electrode to the height “h1” of the sheet nearest to the electrode is less than 10, less than 5, or less than 2.5.

25. The electrolysis stack of claim 20,
wherein the anode flow field comprises exactly two corrugated, porous sheets, and
wherein the average thickness of the cells in the stack core is less than 5 mm, less than 3 mm, or less than 2.5 mm.

26. The electrolysis stack of claim 20,
wherein the structural wrap serves as a tensile element of the compression system, and
wherein the one or more wrap layers are essentially flat sheets of material having an essentially uniform thickness.

27. The electrolysis stack of claim 20,
wherein a total thickness of the one or more wrap layers is determined by an x-axis dimension of the cell stack and the maximum allowable working pressure of the electrolyzer cell stack.

28. A method of operating and electrolysis cell,
wherein the reactants entering the anode flow field comprise liquid water containing no more than 1% by weight of elements other than hydrogen and oxygen, and
wherein the products exiting the cathode flow field have a non-zero vapor phase moisture content, and
wherein the anode flow field comprises one or more porous sheets having at least one straight edge, and
wherein at least one of the porous sheets has the form of a corrugated pattern with a plurality of peaks and valleys whose axes are generally aligned with one straight edge of the sheet and which protrude a height “h” along a z-axis which is generally aligned with the thickness dimension of said sheet.

29. A method of fabricating an anode flow field for an electrolysis cell,
wherein a continuous process of corrugation and lamination is performed,
wherein the web from one coil of flat, porous material (“web1”) is directed through a pair of rollers configured to corrugate said web with a plurality of peaks and valleys with a corrugation pitch of “p1”, and
wherein the axes of the corrugations of “web1” are generally aligned with the axis of the coil, and
wherein the height “h1” of the corrugations of “web1” extend along a z-axis which is generally aligned with the thickness dimension of “web1”, and
wherein the web from a second coil of flat, porous material (“web2”) is directed through a pair of rollers configured to corrugate said web with a plurality of peaks and valleys with a corrugation pitch of “p2”, and
wherein the axes of the corrugations of “web2” are generally aligned with the uncoiling direction of “web2”, and
wherein the height “h2” of the corrugations of “web2” extend along a z-axis which is generally aligned with the thickness dimension of “web2”, and
wherein after passing through the corrugation rollers, “web1” and “web2” are brought adjacent to each other, and
wherein the two layers are spot welded to each other periodically across the web width and along the uncoiling direction length, and
wherein discrete anode flow field components are cut from the laminated web by laser cutting, roller-die cutting or punching.
